(19) United States
(12) Patent Application Publication
(10) Pub. No.: US 2020/0156633 A1
(43) Pub. Date: May 21, 2020

(54) METHOD AND CONTROL UNIT FOR OPERATING AN AUTONOMOUS VEHICLE

(71) Applicant: ZF Friedrichshafen AG, Friedrichshafen (DE)

(72) Inventor: Tobias STEPHAN, Wasserburg (DE)

(73) Assignee: ZF Friedrichshafen AG, Friedrichshafen (DE)

(21) Appl. No.: 16/682,289

(22) Filed: Nov. 13, 2019

(30) Foreign Application Priority Data
Nov. 16, 2018 (DE) 102018219665.6

(51) Int. Cl. B60W 30/095; G05D 1/02; B60W 30/16; G01C 21/36

(52) U.S. Cl. CPC B60W 30/0956; G01C 21/3667; B60W 30/16; G05D 1/021

(57) ABSTRACT

The invention relates to a control unit for autonomous driving for a vehicle, which comprises a processor that is configured to determine a corrected driving position with respect to a planned driving maneuver, by means of which a detection range of environment sensors in or on the vehicle is improved with respect to the planned driving maneuver.

### RELATED APPLICATIONS

This application claims priority from German Patent Application DE 10 2018 219 665.6, filed Nov. 16, 2018, the entirety of which is hereby incorporated by reference herein.

### TECHNICAL FIELD

The present invention relates to a method and a control unit for operating an autonomous vehicle.

### TECHNICAL BACKGROUND

An autonomous vehicle is a vehicle that can operate in street traffic without a human driver. With autonomous driving, the control system of the vehicle entirely or substantially assumes the role of the driver. Autonomous vehicles can perceive their environment with various sensors, determine their position and that of other road users from the information obtained therefrom, and drive to the destination using the control system and the navigation software in the vehicle, and operate accordingly in street traffic.

As can be derived from DE 10 2014 212 746 A1, the use of automation in driving street vehicles such as automobiles and trucks has increased through the advances made in sensor technologies (e.g. object detection and location tracking), control algorithms and data infrastructures.

In addition to the increases in mobility, in particular for disabled persons and the elderly, automated driving reduces the risk of accidents caused by slow reaction times, drowsiness, distractions and other human factors.

On the other hand, autonomous (self-driving) vehicles may exhibit driving behavior that differs significantly from the driving behavior of vehicles driven by people, e.g. with regard to braking behavior and maneuvering in street traffic.

With regulated distance control, e.g. when driving with adaptive cruise control (ACC), or in stop-and-go driving behind a large, wide object (e.g. a truck with a tall trailer, etc.), the range of detection is limited. A manual driver would move to one side or drop back, depending on the intended course of action.

Current semi-automated systems follow the vehicle in front, aligned with the middle thereof, at a set distance. Future systems must use methods similar to those of a human driver to function intelligently, in order to obtain a maximum front view under the restrictions of the given range of detection and the situational limitations.

Based on this, DE 10 2006 001649 A1 discloses a driving control system in which obstacles such as another vehicle, located in front of the vehicle, are detected by a camera, and the relationship of the field of view limited by the obstacle to the overall field of view is calculated by an image processing system. An electronic control unit generates target control values based on this relationship to regulate the speed and/or a lateral position of the vehicle in a traffic lane through actuators. The vehicle is controlled based on information containing the various obstacles located in front of the vehicle, in order to increase the safety of a driver. The driving control system disclosed in DE 10 2006 001649 A1 is based exclusively on recorded image data.

### SUMMARY

Based on this, the fundamental object of the invention is to provide a method and a control unit for operating an autonomous vehicle that optimizes the driving behavior of the vehicle.

This object is achieved by the control unit for autonomous driving according to claim 1 and the method according to claim 10. Further advantageous embodiments of the invention can be derived from the dependent claims and the following description of preferred exemplary embodiments of the present invention.

In accordance with the exemplary embodiments described below, a control unit for autonomous driving is provided that comprises a processor, which is configured to determine a corrected driving position with respect to a planned driving maneuver, through which a detection range of environment sensors of the vehicle is improved with regard to the planned driving maneuver.

In particular, the processor is configured to determine a corrected driving position with respect to a planned driving maneuver, in which the range of detection of the environment sensors has a better coverage of the area of the environment relevant to the planned driving maneuver.

The planned driving maneuver can relate to a specific driving situation, for example, representing an objective, given spatial and temporal constellation of the traffic relevant impact parameters of the functional environment of a vehicle. Driving maneuvers can be predefined in the control unit, and determined, for example, through contextual information (e.g. position of the vehicle, navigation context, etc.) and vehicle operating parameters (speed, transverse acceleration, torque). A planned driving maneuver can be determined, for example—as is known to the person skilled in the art—through contextual information (position of the vehicle, navigation context) and vehicle operating parameters (speed, transverse acceleration, torque). Examples of driving maneuvers are “upcoming left turn,” “pass at the next opportunity,” “exit the highway,” “drive around a stationary vehicle,” “upcoming right turn,” “pull over to stop,” etc.

The control unit for autonomous driving can be a control unit (English: ECU: electronic control unit, or ECM: electronic control module), for example. The control unit for autonomous driving (e.g. an “autopilot”) can be used, for example, in an autonomous vehicle, such that this vehicle can operate in street traffic entirely or partially without the influence of a human driver. The control unit can be located in the vehicle, or it can be outside, or partially outside, the vehicle. Image data can also be obtained in a vehicle and sent to a server or cloud system, where an optimal driving position of the vehicle is determined based on the transmitted image data and a planned driving maneuver, and the results are returned to the vehicle. Accordingly, the control unit, or control logic, can also be located entirely or partially outside the vehicle. The control logic can thus be an algorithm that runs on a server or a cloud system.

The processor can be a computing unit, for example, such as a central processing unit (CPU) that executes program instructions.

The environment sensors can be environment sensors mounted on the vehicle, which self-sufficiently detects objects or situations in the environment of the vehicle, i.e. without external information signals. These include, in particular, cameras, radar sensors, lidar sensors, ultrasound sensors, etc.

The processor can also be configured to determine the corrected driving position in a regulated distance control of the vehicle behind a forward vehicle that limits the range of detection of the vehicle's environment sensors.

The forward vehicle can be a truck with a tall trailer, etc.

The regulated distance control can relate to driving with adaptive cruise control, or driving in a stop-and-go mode behind a forward vehicle.

By way of example, the regulated distance control can be implemented by means of a distance regulating cruise control functionality, which incorporates the distance to a forward vehicle in the control as an additional feedback and regulating variable.

The processor can also be configured to determine the corrected driving position based on information from a sensor-based environment model. Information such as the exact position of the forward vehicle or the visible course of the roadway detected by means of the environment sensors, for example, can be drawn on to determine the corrected driving position. Furthermore, the actual position of the vehicle known through positioning systems (e.g. GPS) can also be drawn on for determining the corrected driving position.

Furthermore, route information can be drawn on via a navigation system to determine the corrected driving position. According to one exemplary embodiment of the invention, the control unit for autonomous driving knows the route from the navigation system, and the control unit for autonomous driving optimizes the driving position with respect to an upcoming driving maneuver based on this information, e.g. an upcoming left curve, a planned turn, deviation, etc.

Furthermore, information from so-called high definition (HD) maps can be drawn on. High definition maps provide a highly precise and realistic 3D model of the street grid. The autonomous vehicle can determine its position precisely and independently of navigation systems through the permanent comparison of the data obtained by its sensors in real time with the stored street and environment data in the HD maps, be informed of potential hazards, traffic jams, or other things that are relevant to traffic, and determine the positions of potential stationary obstacles. The vehicle can also plan and execute maneuvers based on such data. The processor can also be configured to determine the corrected driving position in accordance with the acceptable traffic lane area. In particular, the visible traffic lane can be drawn on for determining the corrected driving position. By way of example, the processor can take the middle traffic lane or the lane markings into account in determining the corrected driving position. If, for example, a determined target position lies within the acceptable lane area, the new position is then set.

The processor can also be configured to determine the corrected driving position based on a geometric model. By way of example, a relative position and the size of a forward vehicle can be determined on the basis of environment sensor data, and the relative position of the forward vehicle in relation to a potential corrected driving position, as well as the region of the environment sensors concealed by the forward vehicle can then be determined with respect to the potential corrected driving position using a geometric model. In this manner, the driving position that enables an optimal or improved detection range of the environment sensors can be calculated in advance, and the control unit for autonomous driving can select an improved or optimized driving position based on this calculation, and adjust accordingly thereto. As a result, the detection range of the environment sensors can optimally or better cover the environment region relevant to the driving maneuver.

The processor can also be configured to determine the corrected driving position based on the position of the forward vehicle. By way of example, the processor can define the corrected driving position by a trailing distance of the vehicle to the forward vehicle and/or a lateral displacement in relation to the forward vehicle.

The processor can also be configured to set the determined corrected driving position. By way of example, the processor can set the corrected driving position by actuating actuators in vehicle subsystems based on information from environment sensors etc. The actuators can be steering, brake, and/or drive actuators. The control unit for autonomous driving can actuate a control unit for a steering system, a control unit for a braking system, and/or a control unit for a drive train, such that specific driving maneuvers are executed.

The invention also relates to a vehicle that has a control unit for autonomous driving according to the invention. The vehicle can be a motor vehicle such as a passenger automobile, a truck, etc.

The invention also relates to a method for autonomous driving, in which a corrected driving position is determined with respect to a planned driving maneuver, through which the detection range of the environment sensors is improved with regard to the planned driving maneuver. The method can be a method implemented by a computer.

### BRIEF DESCRIPTION OF THE DRAWINGS

Embodiments shall be described below, merely by way of example, in reference to the attached drawings. Therein:

FIG. 1 shows a block diagram, which schematically illustrates the configuration of an autonomous vehicle according to an exemplary embodiment of the present invention;

FIG. 2 shows a block diagram illustrating an exemplary configuration of a control unit for autonomous driving;

FIG. 3 shows a typical driving situation for an autonomously driven vehicle;

FIG. 4 shows a table, indicating how various planned driving maneuvers are assigned specific changes in the vehicle position within the traffic lane according to an exemplary embodiment of the invention;

FIG. 5 shows a flow chart illustrating an exemplary embodiment of the method according to the present invention, in which the control unit for autonomous driving adjusts the lateral position of the vehicle within the traffic lane based on the planned driving maneuver;

FIG. 6a shows a vehicle in a position within the traffic lane as it approaches a forward vehicle, where the planned driving maneuver is a left curve;

FIG. 6b shows the vehicle from FIG. 6a in a lateral position within the traffic lane, corrected according to the invention, when the vehicle is trailing the forward vehicle, where the planned driving maneuver is a left curve;

FIG. 6c shows a vehicle in a position within a traffic lane as it approaches a forward vehicle where the planned driving maneuver is a right turn;

FIG. 6d shows the vehicle in FIG. 6c in a lateral position within the traffic lane corrected according to the present invention, as the vehicle trails the forward vehicle where the planned driving maneuver is a right turn;

FIG. 7a shows a vehicle in a position within the traffic lane as it approaches a stationary visibility obstacle, where the planned driving maneuver is a left curve;

FIG. 7b shows the vehicle from FIG. 7a in a lateral position within the traffic lane corrected according to the present invention;

FIG. 8 shows a table listing how various planned driving maneuvers are assigned specific changes in the trailing distance of the vehicle to the forward vehicle according to an alternative exemplary embodiment of the invention;

FIG. 9 shows a flow chart that illustrates an alternative exemplary embodiment of the method according to the present invention, in which the control unit for autonomous driving adjusts the trailing distance of the vehicle to the forward vehicle based on the planned driving maneuver;

FIG. 10a shows a vehicle at a distance d to a forward vehicle, wherein the planned driving maneuver is a left curve;

FIG. 10b shows the vehicle from FIG. 10a at a distance to the forward vehicle, corrected according to the alternative exemplary embodiment of the method of the present invention;

FIG. 11 shows a table, that illustrates how various planned driving maneuvers and changes in the lateral displacement of the vehicle within the traffic lane, as well as the trailing distance of the vehicle to the forward vehicle, are classified, according to another alternative exemplary embodiment of the invention;

FIG. 12a shows a vehicle when it detects a forward vehicle at a distance d in front of the vehicle, and the planned driving maneuver is a passing maneuver at the next opportunity;

FIG. 12b shows the vehicle from FIG. 12a in a position in relation to the forward vehicle and the traffic lane that has been corrected according to the other alternative exemplary embodiment of the method of the present invention; and

FIG. 13 shows a drawing that illustrates the calculation of a corrected vehicle position based on geometric models.

### DETAILED DESCRIPTION

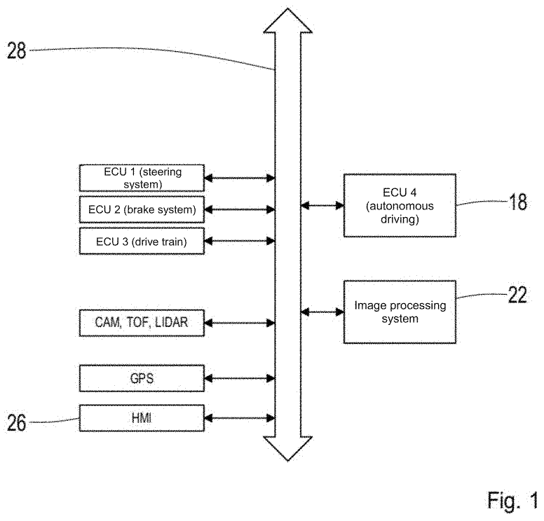

FIG. 1 shows a block diagram that schematically illustrates the configuration of a vehicle 1 that has a control unit for autonomous driving according to an exemplary embodiment of the present invention. The autonomous vehicle 1 comprises numerous electronic components that are connected to one another via a vehicle communications network 28. The vehicle communications network 28 can be a standard vehicle communications network installed in a vehicle, for example, such as a CAN bus (controller area network), a LIN bus (local interconnect network), a LAN bus (local area network), a MOST bus, and/or a FlexRay bus (registered trademark), etc.

In the example shown in FIG. 1, the autonomous vehicle 1 comprises a control unit 12 (ECU 1). This control unit 12 controls a steering system. The steering system comprises the components that enable directional control of the vehicle.

The autonomous vehicle 1 also comprises a control unit 14 (ECU 2), which controls a braking system. The braking system comprises the components enabling a braking of the vehicle.

The autonomous vehicle 1 also comprises a control unit 16 (ECU 3), which controls a drive train. The drive train comprises the drive components of the vehicle. The drive train can comprise a motor, a drive, a drive/propeller shaft, a differential, and an axle drive.

The autonomous vehicle 1 also comprises a control unit for autonomous driving 18 (ECU 4). The control unit for autonomous driving 18 is configured to control the autonomous vehicle 1 such that it can operate entirely or partially without the influence of a human driver in street traffic.

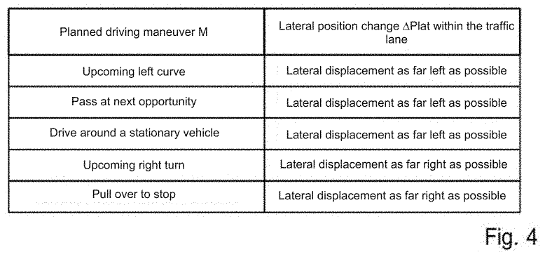

The control unit for autonomous driving 18, which is illustrated in FIG. 4 and described in greater detail in the associated description, controls one or more vehicle systems while the vehicle is operated in the autonomous mode, specifically the brake system 14, the steering system 12, and the drive train 14. The control unit for autonomous driving 18 can communicate, via the vehicle communications network 28 for example, with the corresponding control units 12, 14, 16 for this. The control units 12, 14, and 16 can also receive vehicle operating parameters from the aforementioned vehicle subsystems, which detect these parameters by means of one or more vehicle sensors. Vehicle sensors are preferably those sensors that detect a state of the vehicle or a state of vehicle components, in particular their movement states. The sensors can comprise a vehicle speed sensor, a yaw rate sensor, an acceleration sensor, a steering wheel angle sensor, a vehicle load sensor, temperature sensors, pressure sensors, etc. By way of example, sensors can also be placed along the brake lines in order to output signals indicating the brake fluid pressure at various points along the hydraulic brake lines. Other sensors can be placed in the vicinity of the wheels, which detect the wheel speeds and the brake pressures applied to the wheels.

The vehicle sensor system of the autonomous vehicle 1 also comprises a satellite navigation unit 24 (GPS) unit. It should be noted that in the context of the present invention, GPS can stand for any global navigation satellite system (GNSS), e.g. GPS, A-GPS, Galileo, GLONASS (Russia), Compass (China), IRNSS (India), etc.

When an operating state of the autonomous vehicle is activated by the control or the driver, the control unit for autonomous driving 18 determines parameters for the autonomous operation of the vehicle (e.g. target speed, target torque, distance to forward vehicle, distance to traffic lane edge, steering procedure, etc.) based on available data regarding a predefined route, environment data recorded by environment sensors, and vehicle operating parameters obtained by the vehicle sensors, which are supplied to the control unit 18 from the control units 12, 14, and 16.

The autonomous vehicle 1 also comprises one or more environment sensors 20 that are configured to record the environment of the vehicle 1, wherein the environment sensors 20 are mounted on the vehicle and detect objects or states in the environment of the vehicle self-sufficiently, i.e. without external information signals. These include, in particular, cameras, radar sensors, lidar sensors, ultrasound sensors, etc. The environment sensors 20 can be placed inside our outside the vehicle (e.g. on the outer surface of the vehicle). By way of example, a camera can be built into a front region of the vehicle 1 for recording images of the region in front of the vehicle.

The control unit for autonomous driving 18 can measure the position and speed of the forward vehicle via the environment sensors 20 for the adaptive cruise control (ACC), and accordingly adjust the speed of the vehicle as well as the distance to the forward vehicle by engaging the drive or brakes.

The autonomous vehicle 1 can also comprise an image processing system 22 for processing image data, e.g. image data of an image of the region in front of the vehicle itself, recorded by a camera, in the direction of travel. Obstacles such as a forward vehicle (2 in FIG. 1) located in the front field of view of a vehicle are recorded by the camera and the image data are sent to the image processing system. The image processing system processes the image data obtained from the camera in order to generate and provide information regarding the obstacle in front of the vehicle, e.g. a forward vehicle, and the vehicle itself in a traffic lane. By way of example, the image processing system can derive a shape and width of the traffic lane and a lateral position of the vehicle 1 within the traffic lane from the shape and position of the traffic lane markings. This information is sent to the control unit for autonomous driving 18, and can be incorporated in the determination of the vehicle operating parameters.

The autonomous vehicle 1 also comprises a user interface 26 (HMI: human-machine interface), enabling a vehicle occupant to interact with one or more of the vehicle systems. This user interface 26 can comprise an electronic display (e.g. a GUI: graphical user interface) for outputting a graphic comprising symbols and/or content in the form of text, and an input interface for receiving an input (e.g. manual input, speech input, and inputs through gestures, e.g. head or eye movements). The input interface can comprise, e.g., keyboards, switches, touchscreens, eye trackers, etc.

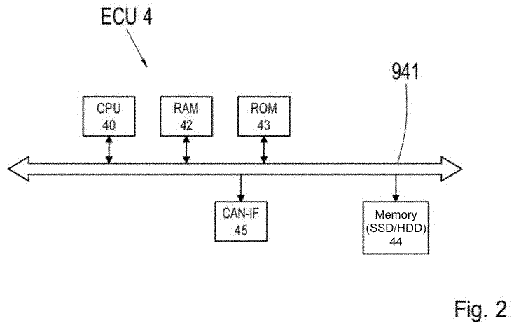

FIG. 2 shows a block diagram illustrating an exemplary configuration of a control unit for autonomous driving 18 (ECU 4). The control unit for autonomous driving 18 can be a control device (electronic control unit ECU, or electronic control module ECM). The control unit for autonomous driving 18 (ECU 4) comprises a processor 40. The processor can be a computing unit, e.g. a central processing unit (CPU) that executes program instructions.

The processor of the control unit for autonomous driving 18 is configured to calculate an optimal driving position (trailing distance, lateral displacement) with respect to a planned driving maneuver, on the basis of the information from the sensor-based environment model, taking the acceptable traffic lane region into account. The computed optimal driving position is used for controlling actuators in the vehicle subsystems 12, 14, 16, e.g. brake, drive, and/or steering actuators.

The control unit for autonomous driving 18 also comprises a memory and an input/output interface. The memory can be composed of one or more non-volatile computer readable mediums, and comprises at least one program storage region and one data storage region. The program storage region and the data storage region can comprise combinations of different types of memory, e.g. a read only memory 43 (ROM) and a random access memory 42 (RAM) (e.g. dynamic RAM (“DRAM”), synchronous DRAM (“SDRAM”), etc.). The control unit for autonomous driving 18 also comprises an external memory disk drive 44, e.g. an external hard disk drive (HDD), a flash drive, or a non-volatile solid state drive (SSD).

The control unit for autonomous driving 18 also comprises a communications interface 45, via which the control unit can communicate with the vehicle communications network (28 in FIG. 2).

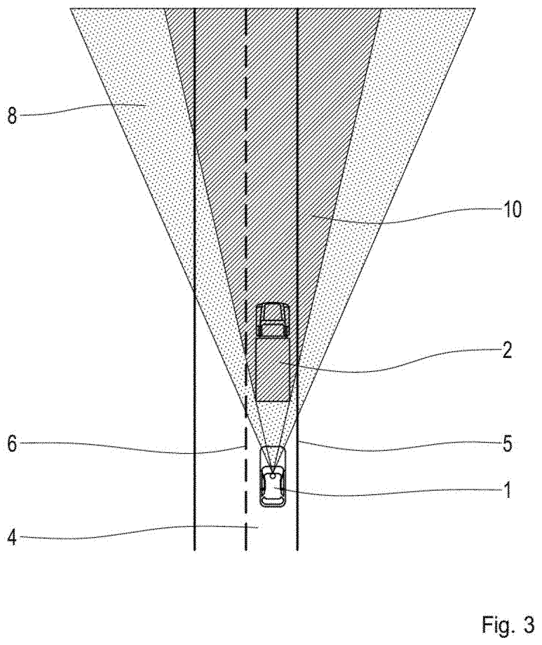

FIG. 3 shows a typical driving situation for an autonomously driven vehicle. An autonomously driven vehicle 1 travels in the right-hand lane 4 of a street 5. The autonomous vehicle 1 comprises a control unit for autonomous driving (18 in FIG. 1), which determines parameters for the autonomous operation of the vehicle (e.g. target speed, target torque, distance to forward vehicle, distance to traffic lane edge, steering procedure, etc.) based on available data regarding a predefined route, environment data obtained from environment sensors 20, and vehicle operating parameters obtained by means of the vehicle sensors that are sent to the control unit 18 from the control units 12, 14, and 16.

As can be seen in FIG. 3, the autonomous vehicle 1 is trailing a forward vehicle, in this case a truck 2, that conceals a region 10 of the detection range 8 of the environment sensors (20 in FIG. 1) of the vehicle 1, in particular a front camera here.

The control unit for autonomous driving of the vehicle 1 comprises a processor that is configured to calculate an optimal driving position with respect to a planned driving maneuver on the basis of information from a sensor-based environment model, taking the acceptable traffic lane region into account, the region of which that is to be recorded is best covered with the built-in environment sensors (20 in FIG. 1).

FIG. 4 shows, by way of example, how various planned driving maneuvers are assigned specific lateral position changes ΔPₗₐₜ of the vehicle within the traffic lane (lateral displacement) when driving a vehicle 1 behind a forward vehicle 2 that obstructs vision. These assignments can be stored, for example, in the form of a table in a memory (42, 43, 44 in FIG. 2) in the control unit for autonomous driving. The driving maneuver, “upcoming left turn,” is assigned a lateral displacement, “as far left as possible,” within the traffic lane; the driving maneuver, “drive around a stationary vehicle,” is assigned a lateral displacement, “as far left as possible,” within the traffic lane; the driving maneuver, “upcoming right turn,” is assigned a lateral displacement, “as far right as possible,” within the traffic lane; and the driving maneuver, “pull over to stop,” is assigned the lateral displacement, “as far right as possible,” within the traffic lane.

If a forward vehicle 2 that obstructs vision is detected with the one or more environment sensors 20, i.e. the vehicle 1 approaches a forward vehicle 2 that limits the detection range 8, the control unit for autonomous driving 18 regulates the lateral position of the vehicle 1 within the traffic lane 4 based on the planned driving maneuver, taking the stored assignments into account, such that an optimal detection range 8 is ensured for the environment sensors 20 of the vehicle 1 under the situational limitations for executing the planned driving maneuver M. The control unit for autonomous driving 18 accordingly generates target values based on the planned driving maneuver M that are sent to a steering actuator 12, which comprises a motor for driving a steering shaft, such that the motor is actuated on the basis of the target control values input by the control unit for autonomous driving 18.

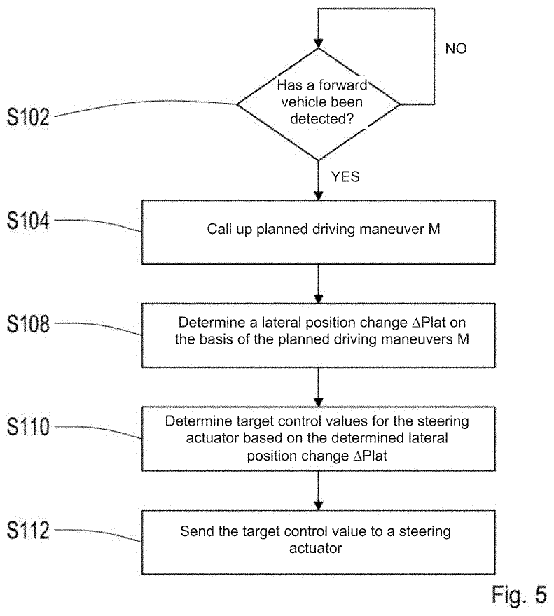

FIG. 5 shows a flow chart illustrating an exemplary embodiment of a method according to the present invention, in which the control unit for autonomous driving adjusts the lateral position of the vehicle 1 within the traffic lane 4 based on the planned driving maneuver. In step S102, it is determined whether a forward vehicle that limits the detection range is detected by the environment sensors in the region in front of the vehicle. If a forward vehicle that limits the detection range is detected, the process continues at step S104. If no forward vehicle is detected, or if a forward vehicle is detected that does not limit the detection range, step S102 is repeated until a forward vehicle is detected that limits the detection range. The control unit for autonomous driving calls up a planned driving maneuver M in step S104 that is determined through contextual information (e.g. position of the vehicle, navigation context, etc.) and vehicle operating parameters (speed, transverse acceleration, torque). The control unit for autonomous driving determines a lateral position change ΔPₗₐₜ in the traffic lane in step S108, based on the planned driving maneuver M. The control unit for autonomous driving generates target values for the steering actuator (steering system 12 in FIG. 1) in step S110, based on the lateral position change ΔPₗₐₜ. The control unit for autonomous driving sends the generated target values to the steering actuator in step S112, and adjusts the position of the vehicle to the corrected lateral position.

According to the present invention, a corrected lateral position is calculated such that an optimal detection range is ensured for the environment sensors for executing the planned driving maneuver.

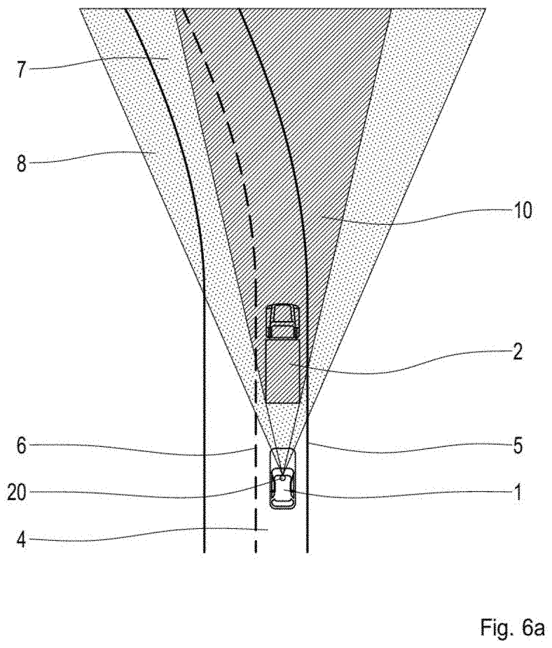

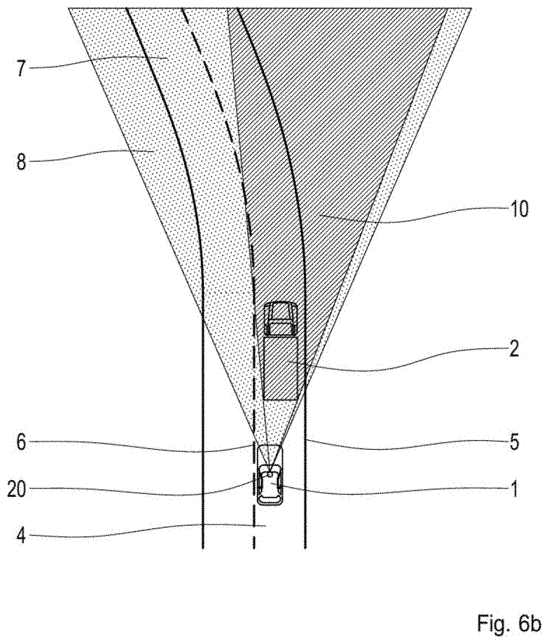

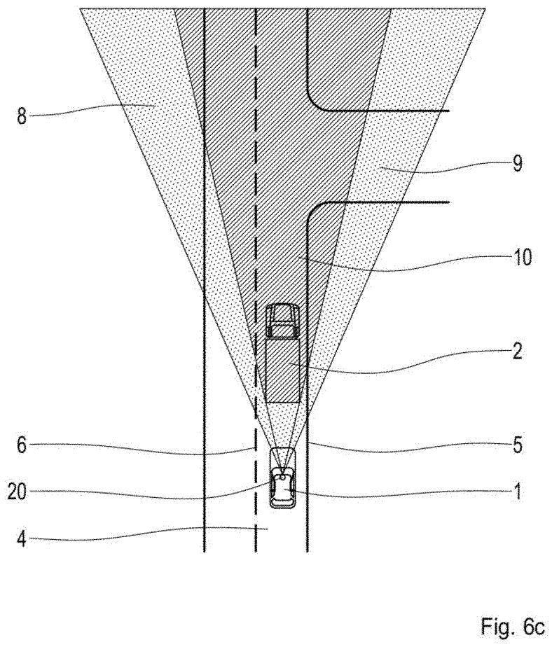

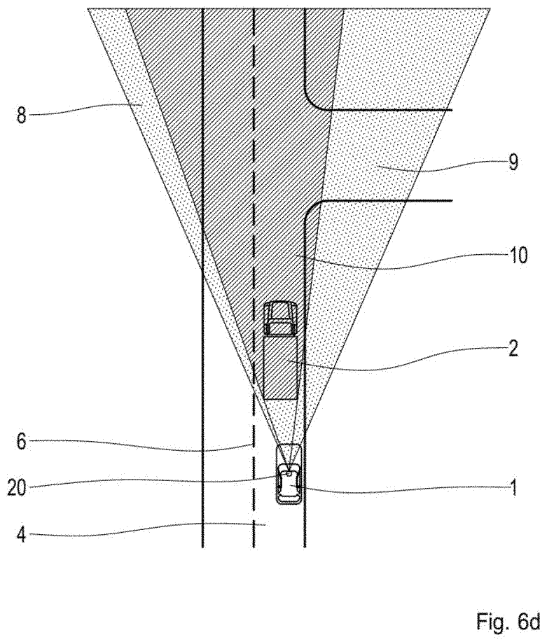

FIGS. 6a-6d each show drawings that illustrate an exemplary embodiment of the method according to the present invention, in which the lateral position of the vehicle is adjusted within the traffic lane based on the planned driving maneuver.

FIG. 6a shows a vehicle 1 in a central position within the traffic lane 4 as it approaches a forward vehicle 2. The vehicle 1 is approaching a left curve 7 in the street 5. As can be seen in FIG. 6a, the detection range 8 of the environment sensors 20 in or on the vehicle 1 is limited by the forward vehicle 2 such that a substantial region of the subsequent left curve 7 lies in the concealed region 10, such that it cannot be detected by the environment sensors 20, and is it more difficult to drive through the upcoming left curve 7. It is known to the control unit for autonomous driving in the vehicle 1 from the context information (e.g. position of the vehicle, navigation context, etc.) and vehicle operating parameters (speed, transverse acceleration, torque), that navigating the upcoming left curve 7 is the next planned driving maneuver.

FIG. 6b shows the vehicle 1 from FIG. 6a in a lateral position that has been corrected within the traffic lane 4 according to the present invention. The control unit for autonomous driving in the vehicle 1 has adjusted to a corrected lateral position of the vehicle corresponding to a lateral displacement, “as far left as possible,” in accordance with the assignment stored in the memory for planned driving maneuvers and associated lateral position changes (FIG. 4) and according to the method described above (FIG. 5). As can be seen in FIG. 6b, the vehicle is further left within the traffic lane 4 than in FIG. 6a. The control unit for autonomous driving in the vehicle 1 has implemented the lateral displacement, “as far left as possible,” in this case, in that it has adjusted to a lateral position in the immediate vicinity of the traffic lane marking 6 via the steering actuator. In this position, the concealed (not detected) region 10 in FIG. 6a is displaced toward the right side, such that the region of the street 5 running in the left curve can be better detected. Accordingly, the subsequent left curve can be better detected by the environment sensors 20, facilitating navigation of the upcoming left curve.

FIG. 6c shows a vehicle 1 in a central position within the traffic lane as it approaches a forward vehicle 2. The vehicle 1 is approaching a right intersection 9 in the street 5. As can be seen in FIG. 6c, the detection range of the environment sensors in or on the vehicle 1 is limited by the forward vehicle 2, such that a substantial region of the upcoming right intersection 9 lies in the concealed region 10, and cannot be detected by the environment sensors 20, such that it is more difficult to navigate an upcoming right turn. It is known to the control unit for autonomous driving in the vehicle 1 from the context information (e.g. position of vehicle, navigation context, etc.) and the vehicle operating parameters (speed, transverse acceleration, torque) that a right turn is planned at the intersection 9.

FIG. 6d shows the vehicle 1 from FIG. 6c in a lateral position within the traffic lane that has been corrected according to the present invention. The control unit for autonomous driving in the vehicle 1 has adjusted a corrected lateral position of the vehicle corresponding to a lateral displacement, “as far right as possible,” in accordance with the assignment of planned driving maneuvers and associated lateral position changes (FIG. 4) stored in the memory and according to the method described above (FIG. 5). As can be seen in FIG. 6d, the vehicle is further right within the traffic lane 4 than in FIG. 6a. The control unit for autonomous driving in the vehicle 1 has implemented the lateral displacement, “as far right as possible,” in this case, in that it has set a lateral position in the immediate vicinity of the right traffic lane marking 4 via the steering actuator. In this position, the concealed (not detected) region 10 in FIG. 6c is displaced toward the left side, such that the region of the street 5 in the right turn 9 can be better detected. Accordingly, the subsequent right turn 9 can be better detected by the environment sensors 20, facilitating navigation through the upcoming right turn.

The extent of the displacement can also depend on the limitation to the detection range caused by the forward vehicle. In particular, the extent of the displacement can be greater if the limitation of the detection range caused by the forward vehicle is greater, i.e. depending on how large the forward vehicle is. The size of the forward vehicle can be determined, for example, by means of image recognition from the data obtained from a front camera on the autonomous vehicle, e.g. depending on the actual size (height and width) of the forward vehicle, or the relationship of the obstructed region caused by the forward vehicle in the camera image to the overall area of the camera image. The control unit adjusts the lateral position of the vehicle in the traffic lane by means of the steering actuator in accordance with the targeted lateral displacement determined by the control unit.

Alternatively, a lateral position of the forward vehicle Pₗₐₜ(VF) in the traffic lane can be calculated in step S106, and the control unit for autonomous driving can calculate a lateral position change ΔPₗₐₜ in the traffic lane in step S108 based on the planned driving maneuver M and the lateral position Pₗₐₜ (VF) of the forward vehicle in the traffic lane.

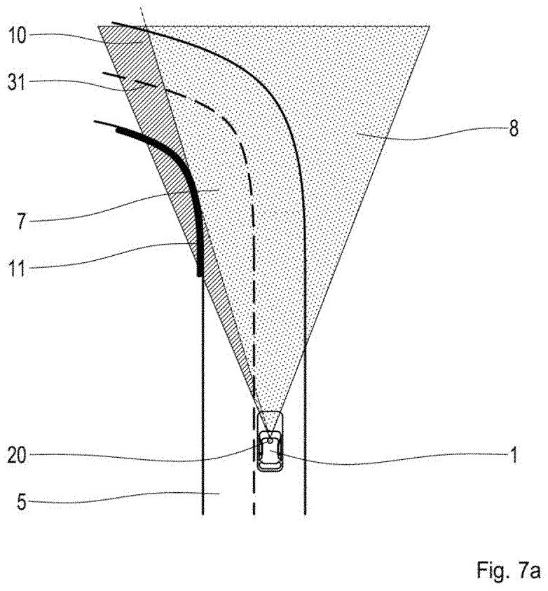

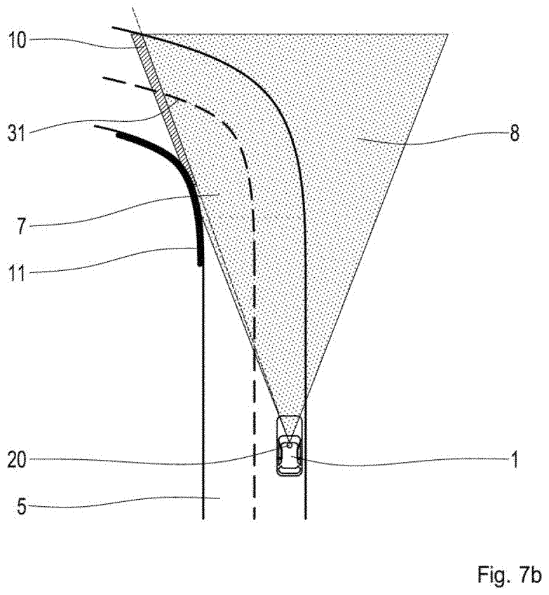

Furthermore, the lateral position can be adjusted in this manner, such that the detection range of the environment sensors is not only improved with respect to the planned driving maneuver when vision is obstructed by a moving vehicle in front of it, but also when vision is obstructed by a stationary obstruction, as FIG. 7 illustrate. In this case, the position of a stationary obstruction can be calculated, and the control unit for autonomous driving can calculate a lateral position change ΔPₗₐₜ in the traffic lane based on the panned driving maneuver M and the position of the obstruction.

FIG. 7a shows a vehicle 1 in a position within the traffic lane 4 as it approaches a stationary visual obstruction, in this case a wall 11. The vehicle is approaching a left curve 7 in the street 5. As can be seen in FIG. 7a, the detection range 8 of the environment sensors 20 in or on the vehicle 1 is limited by the wall 11 such that a substantial region of the subsequent left curve 7 lies in the concealed region 10, i.e. cannot be detected by the environment sensors 20, making navigation of the upcoming left curve 7 more difficult. It is known to the control unit for autonomous driving in the vehicle 1 from the context information (e.g. position of the vehicle, navigation context, etc.) and the vehicle operating parameters (speed, transverse acceleration, torque), that the upcoming left curve 7 is the next planned driving maneuver.

FIG. 7b shows the vehicle 1 from FIG. 7a in a lateral position within the traffic lane 4 that has been corrected according to the present invention. The control unit for autonomous driving in the vehicle 1 has calculated and adjusted the position of the vehicle to a corrected lateral position with respect to the planned driving maneuver M and the position and/or design of the wall 11. The position and/or design of the wall can be determined, for example, using data from high definition maps or camera data. As can be seen in FIG. 7b, the vehicle 1 is further right within the traffic lane 4 than in FIG. 7a. In this position, the region 10 concealed (not detected) by the wall 11 is smaller than in FIG. 7a, such that the region of the street 5 in a left curve can be better detected. As can be seen in FIGS. 7a and 7b, the line 31 marking the center of the traffic lane 6 cannot be detected from the uncorrected position of the vehicle 1, but it can be detected from the corrected position of the vehicle 1. Accordingly, the subsequent left curve can be better detected by the environment sensors 20 from the corrected position, facilitating navigation of the upcoming left curve.

According to an alternative exemplary embodiment of the method of the present invention, instead of regulating the lateral displacement of the vehicle within the traffic lane as described above, the trailing distance of the vehicle to the forward vehicle can be adjusted on the basis of the planned driving maneuver. In particular, if a forward vehicle is detected that limits the detection range, a distance d between the vehicle and the forward vehicle can be calculated on the basis of data obtained from one or more environment sensors (e.g. radar, camera). The trailing distance can be adjusted on the basis of the upcoming driving maneuver.

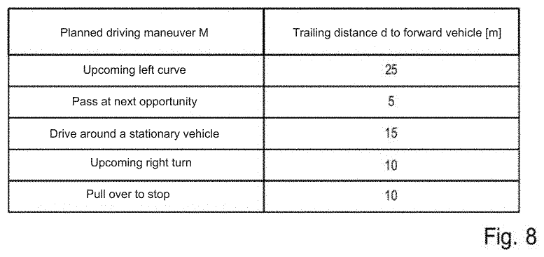

FIG. 8 shows an alternative exemplary embodiment of the method according to the present invention, in which the trailing distance of the vehicle to the forward vehicle is set on the basis of the planned driving maneuver. FIG. 8 shows, by way of example, how various planned driving maneuvers are assigned specific trailing distances d(corr) of the vehicle 1 to the forward vehicle 2 when driving a vehicle 1 behind a vehicle 2 that obstructs vision in the direction of travel. These assignments can be stored, for example, in the form of a table in a memory (42, 43, 44 in FIG. 2) in the control unit for autonomous driving. The driving maneuver, “upcoming left turn,” is assigned a trailing distance d(corr) of 25 m; the driving maneuver, “pass at next opportunity,” is assigned a trailing distance d(corr) of 5 m; the driving maneuver, “drive around a stationary vehicle,” is assigned a trailing distance d(corr) of 15 m; the driving maneuver, “upcoming right turn,” is assigned a trailing distance d(corr) of 10 m; and the driving maneuver, “pull over to stop,” is assigned a trailing distance d(corr) of 10 m. The examples described herein are to be regarded schematically. The person skilled in the art can also make the distance dependent on the speed of the autonomous vehicle with the means known to him, such that at higher speeds, greater distances to the forward vehicle are to be maintained than at lower speeds.

If a vehicle 2 that obstructs vision is detected toward the front by one or more environment sensors, i.e. if the vehicle 1 approaches a vehicle 2 in front of it that limits the detection range 8, the control unit for autonomous driving 18 adjusts the trailing distance d(corr) of the vehicle 1 to the forward vehicle 2 based on the planned driving maneuver M, taking the stored assignments into account, such that an optimal detection range 8 for executing the planned driving maneuver M is ensured under the situational limitations for the environment sensors 20 of the vehicle 1. The control unit for autonomous driving 18 generates target control values for a target acceleration or a target deceleration (negative target acceleration), e.g. based on the determined trailing distance d(corr), the current distance between the vehicle 1 and the forward vehicle 2, and the current speed of the vehicle, which are transmitted to a drive actuator 16 or brake actuator 14, such that the drive actuator or the brake actuator are actuated based on the target control values entered by the control unit for autonomous driving 18. The drive actuator 16 and the brake actuator 14 regulate the speed v of the vehicle based on the target acceleration or target deceleration calculated by the control unit for autonomous driving 18.

Furthermore, the control unit for autonomous driving can incorporate other variables in the calculation of the target acceleration or target deceleration, such as the size of the forward vehicle or the traffic density, or the vehicle speed, as specified above. The size of the forward vehicle can be determined by means of image recognition, for example, from the data obtained by a front camera in or on the autonomous vehicle. A trailing distance that is proportional to the traffic density and/or the size of the forward vehicle is ideal.

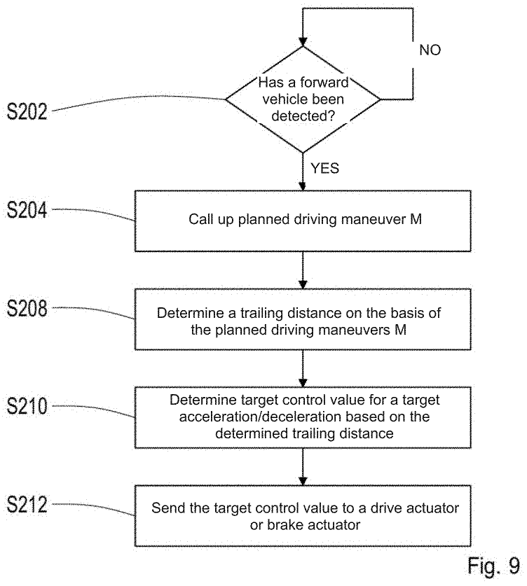

FIG. 9 shows a flow chart that illustrates the alternative exemplary embodiment of the method according to the present invention. It is determined in step S202, using the environment sensors, whether a vehicle has been detected in the region in front of the vehicle that limits the detection range. If a forward vehicle is detected that limits the detection range, the process continues at step S204. If no forward vehicle is detected, or a forward vehicle is detected that does not limit the detection range, step S202 is repeated until a forward vehicle is detected that limits the detection range. The control unit for autonomous driving calls up a planned driving maneuver M in step S204 that is determined by contextual information (e.g. position of the vehicle, navigation context, etc.) and vehicle operating parameters (speed, transverse acceleration, torque). The control unit for autonomous driving determines a trailing distance d(corr) of the vehicle to the forward vehicle in step S208, based on the planned driving maneuver M. In step S210, the control unit for autonomous driving generates target control values for a target acceleration or target deceleration (negative target acceleration) for a drive actuator (drive system 16 in FIG. 1) or a brake actuator (braking system 14 in FIG. 1), based on the trailing distance d(corr) of the vehicle to the forward vehicle, the current distance d between the vehicle and the forward vehicle, and the current speed of the vehicle. The current distance d to the forward vehicle can be obtained on the basis of data from a radar sensor or a stereo camera. In step S212, the control unit for autonomous driving sends the generated target control values to the drive actuator or brake actuator and implements the corrected distance to the forward vehicle.

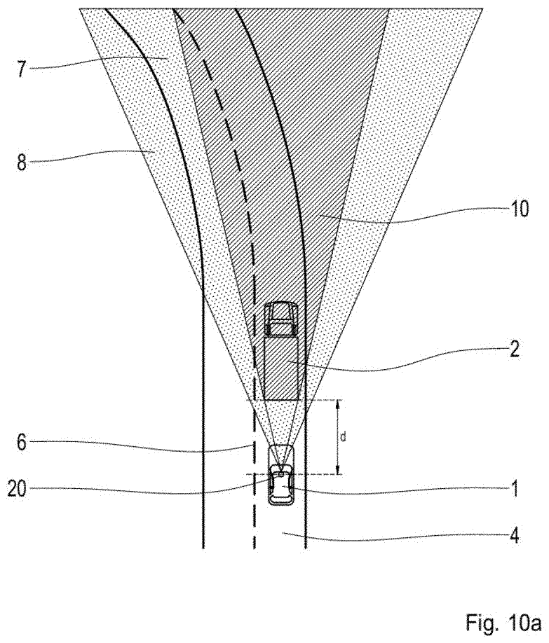

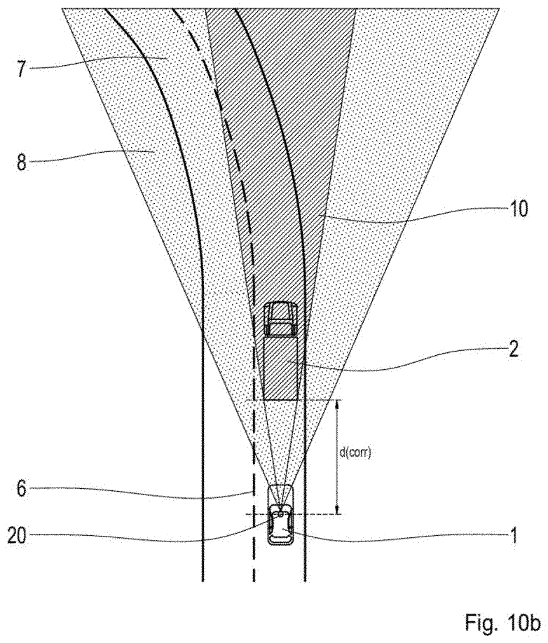

FIGS. 10a and 10b each illustrate the alternative exemplary embodiment of the alternative method according to the present invention in which the trailing distance of the vehicle to the forward vehicle is adjusted on the basis of the planned driving maneuver.

FIG. 10a shows a vehicle 1 at a distance d to a forward vehicle when it approaches a forward vehicle 2. The vehicle 1 is approaching a left curve 7 in the street 5. As can be seen in FIG. 10a, the detection range 8 of the environment sensors 20 of the vehicle 1 is limited by the forward vehicle 2 such that a substantial region of the subsequent left curve lies in the concealed region 10, i.e. cannot be detected by the environment sensors 20, making it more difficult to drive through the upcoming left curve. It is known to the control unit for autonomous driving in the vehicle 1 from the contextual information (e.g. position of the vehicle, navigation context, etc.) and the vehicle operating parameters (speed, transverse acceleration, torque), that navigating the upcoming left curve 7 is the planned driving maneuver.

FIG. 10b shows the vehicle 1 from FIG. 10a at a trailing distance d(corr) to the forward vehicle that has been corrected according to the present invention. As can be seen in FIG. 10b, the vehicle 1 is at a greater trailing distance d(corr) to the forward vehicle 2 than in FIG. 10a. The control unit for autonomous driving in the vehicle 1 is at a trailing distance of 25 m here, that implements the maneuver assigned to “upcoming left curve,” in that it sends a corresponding target control value for a target deceleration to the brake actuator. In this position, the concealed (not detected) region 10 in FIG. 10a is narrowed, such that the region of the street 5 entering a left curve can be better detected. Accordingly, the subsequent left curve can be better detected by the environment sensors 20, facilitating navigation of an upcoming left curve.

According to another alternative exemplary embodiment of the method of the present invention, numerous position parameters can be simultaneously regulated on the basis of the planned driving maneuver, e.g. both the lateral displacement as well as the trailing distance, instead of the lateral displacement of the vehicle within the traffic lane or the trailing distance of the vehicle to the forward vehicle described above.

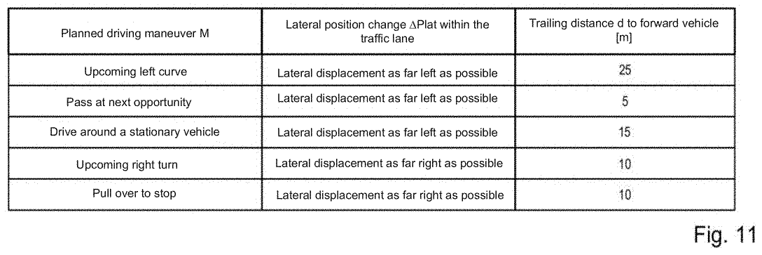

FIG. 11 shows another alternative exemplary embodiment of the method according to the present invention, in which both the lateral displacement of the vehicle within the traffic lane as well as the trailing distance of the vehicle to the forward vehicle are adjusted on the basis of the planned driving maneuver. FIG. 11 shows, by way of example, how various planned driving maneuvers are assigned specific lateral position changes ΔPₗₐₜ of the vehicle 1 within the traffic lane, as well as the trailing distance d(corr) of the vehicle 1 to the forward vehicle when driving a vehicle 1 behind a forward vehicle 2 that obstructs the view. These assignments can be stored, for example, in the form of a table in a memory (42, 43, 44 in FIG. 2) in the control unit for autonomous driving. The driving maneuver, “upcoming left turn,” is assigned a lateral displacement, “as far left as possible,” within the traffic lane, and a trailing distance d(corr) of 25 m; the driving maneuver, “pass at next opportunity,” is assigned a lateral displacement, “as far left as possible,” within the traffic lane and a trailing distance d(corr) of 5 m; the driving maneuver, “drive around a stationary vehicle,” is assigned a lateral displacement, “as far left as possible,” within the traffic lane and a trailing distance d(corr) of 15 m; the driving maneuver, “upcoming right turn,” is assigned a lateral displacement, “as far right as possible,” within the traffic lane and a trailing distance d(corr) of 10 m; and the driving maneuver, “pull over to stop,” is assigned a lateral displacement, “as far right as possible,” within the traffic lane and a trailing distance d(corr) of 10 m.

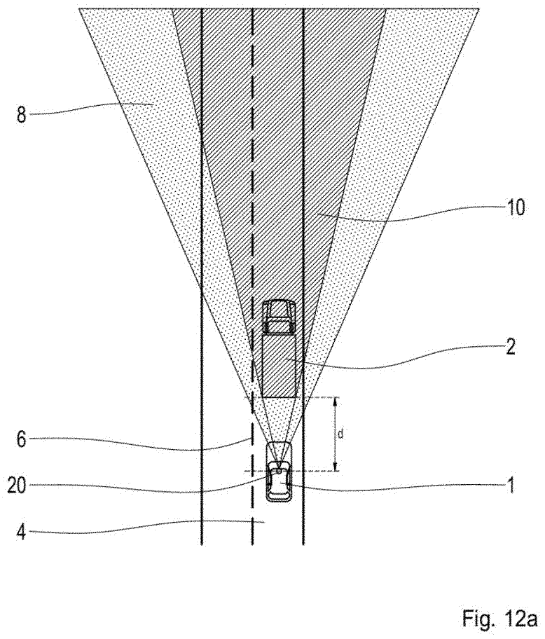

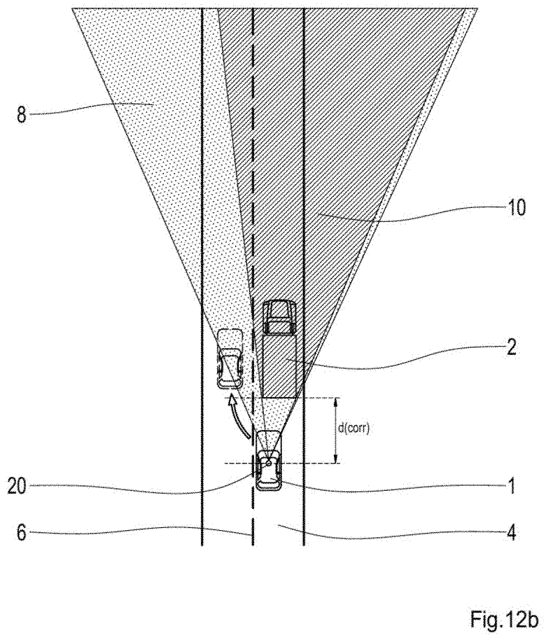

FIGS. 12a and 12b each illustrate the further alternative exemplary embodiment of the method according to the present invention in which both the lateral position of the vehicle within the traffic lane as well as the trailing distance of the vehicle to the forward vehicle are adjusted on the basis of the planned driving maneuver.

FIG. 12a shows a vehicle 1 at a distance d to a forward vehicle as it approaches the forward vehicle 2. It is known to the control unit for autonomous driving in the vehicle 1 from the contextual information (e.g. position of the vehicle, navigation context, etc.) and the vehicle operating parameters (speed, transverse acceleration, torque), that the upcoming planned driving maneuver comprises passing at the next opportunity.

FIG. 12b shows the vehicle 1 from FIG. 12a in a position that has been corrected in relation to the forward vehicle and the traffic lane according to the further alternative exemplary embodiment of the method according to the present invention. The control unit for autonomous driving sets a short distance to the forward vehicle 2 on the basis of the planned passing procedure. In this manner, the length of the passing procedure can be shortened. At the same time, the lateral position within the traffic lane is displaced to the left, in order to ensure a better view for assessing the oncoming traffic. The control unit for autonomous driving in the vehicle 1 sets a corrected position of the vehicle in accordance with the assignments of planned driving maneuvers and associated position parameters (FIG. 11) stored in the memory, which corresponds to a lateral displacement, “as far left as possible,” and a trailing distance of 5 m.

According to the exemplary embodiments described above, the control unit for autonomous driving sets a vehicle position (lateral displacement, trailing distance) that is assigned to a specific driving maneuver in accordance with a table stored in the memory of the control unit.

Alternatively, the control unit for autonomous driving can calculate a corrected vehicle position on the basis of geometric models, taking the acceptable traffic lane region into account, from which a region that is to be detected for executing the planned driving maneuver is optimally covered by the detection range of the built-in environment sensors.

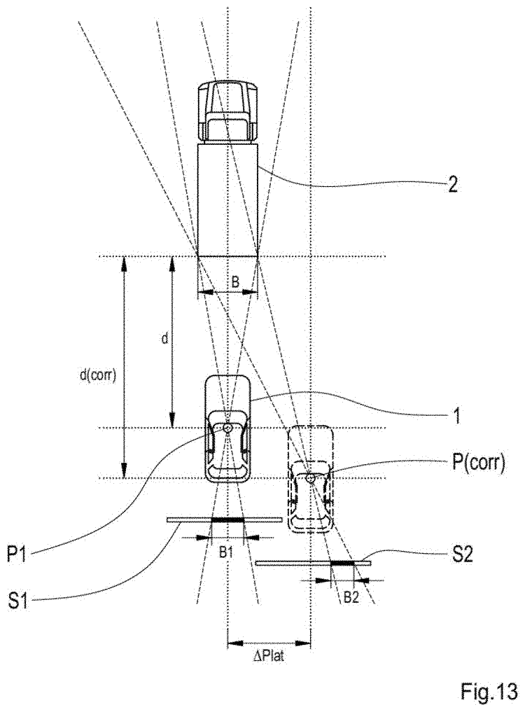

FIG. 13 illustrates the calculation of a corrected vehicle position based on geometric models. The autonomous vehicle 1 comprises an image processing system (22 in FIG. 1) for processing image data of an image of the region in front of the vehicle recorded in the direction of travel by a stereo camera. A forward vehicle 2 located in the front field of view of the vehicle 1 is recorded by the stereo camera, and the image data S1 are sent to the image processing system. The image processing system processes the image data S1 obtained from the camera in order to identify the forward vehicle 2 and to determine its size B1 in the camera image S1. The stereo camera provides information regarding the distance d to the forward vehicle 2 with respect to the vehicle 1 and the lateral position of the forward vehicle 2 in relation to the vehicle 1. In this manner, a surface area, or a width B of the rear surface of the forward vehicle 2 can be determined by projecting the image B1 onto the image plane S1. As the broken projection lines show in FIG. 13, the control unit for autonomous driving can determine the size B1 of the forward vehicle 2 in a virtual camera image S2, which corresponds to a corrected position P(corr) of the vehicle 1, or the stereo camera, respectively. In this manner, the control unit for autonomous driving can determine a corrected position P(corr) that is defined by a trailing distance d(corr) and a lateral position change ΔPₗₐₜ of the vehicle 1 within the traffic lane, and in which the detection range of the environment sensors is improved.

### REFERENCE SYMBOLS

1 autonomous vehicle
2 forward vehicle
4 traffic lane
5 street
6 traffic lane center marking
7 left curve
8 detection range
9 right turn
10 concealed region
11 wall
12 control unit for steering system
14 control unit for braking system
16 control unit for drive train
18 control unit for autonomous driving
20 environment sensors
22 image processing system
24 satellite navigation system
26 user interface
28 vehicle communications network
31 line marking the middle of the traffic lane
40 processor
42 RAM memory
43 ROM memory
44 memory drive
45 user interface

1. A control unit for autonomous driving for a vehicle, the control unit comprising a processor configured to:
determine a planned driving maneuver; and
determine a corrected driving position in relation to a current driving position and with respect to the planned driving maneuver, wherein a detection range of at least one environment sensor in or on the vehicle is improved with respect to the planned driving maneuver when the vehicle is in the corrected driving position as compared to the current driving position.

2. The control unit for autonomous driving according to claim 1, wherein the processor is configured to:
determine the corrected driving position using a regulated distance control of the vehicle behind a forward vehicle, wherein the forward vehicle limits the detection range of the at least one environment sensor.

3. The control unit for autonomous driving according to claim 1, wherein the processor is configured to:
determine the corrected driving position based at least in part on information of a sensor-based environment model.

4. The control unit for autonomous driving according to claim 1, wherein the processor is configured to:
utilize route information from at least one of a navigation system or a high definition map to determine the corrected driving position.

5. The control unit for autonomous driving according to claim 1, wherein the processor is configured to:
determine the corrected driving position taking an acceptable traffic lane region into account.

6. The control unit for autonomous driving according to claim 1, wherein the processor is configured to:
determine the corrected driving position utilizing a geometric model of a forward vehicle.

7. The control unit for autonomous driving according to claim 1, wherein the processor is configured to:
utilize a position of at least one of a forward vehicle or a stationary view obstruction to determine the corrected driving position.

8. The control unit for autonomous driving according to claim 1, wherein the corrected driving position is defined by at least one of a trailing distance of the vehicle to a forward vehicle or a lateral displacement of the vehicle in relation to the forward vehicle.

9. The control unit for autonomous driving according to claim 1, wherein the processor is configured to:
cause the vehicle to move to the corrected driving position.

10. A method for autonomous driving, the method comprising:
determining, by a processor of a control unit for autonomous driving for a vehicle, a planned driving maneuver of the vehicle; and
determining, by the processor, a corrected driving position in relation to a current driving position with respect to the planned driving maneuver, wherein a detection range of at least one environment sensor in or on the vehicle is improved with respect to the planned driving maneuver when the vehicle is in the corrected driving position as compared to the current driving position.

11. The method for autonomous driving of claim 10, further comprising:
determining, by the processor, the corrected driving position using a regulated distance control of the vehicle behind a forward vehicle, wherein the forward vehicle limits the detection range of the at least one environment sensor.

12. The method for autonomous driving of claim 10, further comprising:
determining, by the processor, the corrected driving position based at least in part on information of a sensor-based environment model.

13. The method for autonomous driving of claim 10, further comprising:
determining, by the processor, the corrected driving position based at least on part on route information from at least one of a navigation system or a high definition map.

14. The method for autonomous driving of claim 10, further comprising:
determining, by the processor, the corrected driving position based at least on part on an acceptable traffic lane region.

15. The method for autonomous driving of claim 10, further comprising:
determining, by the processor, the corrected driving position based at least on part on a geometric model of a forward vehicle.

16. The method for autonomous driving of claim 10, further comprising:
determining, by the processor, the corrected driving position based at least on part on a position of at least one of a forward vehicle or a stationary view obstruction.

17. The method for autonomous driving of claim 10, further comprising:
determining, by the processor, the corrected driving position comprising at least one of a trailing distance of the vehicle to a forward vehicle or a lateral displacement of the vehicle in relation to the forward vehicle.

18. The method for autonomous driving of claim 10, further comprising:
causing, by the processor, the vehicle to move to the corrected driving position.
